(19) United States
(12) Patent Application Publication
(10) Pub. No.: US 2013/0110567 A1
(43) Pub. Date: May 2, 2013

(54) HUMAN CAPITAL ASSESSMENT AND RANKING SYSTEM

(71) Applicant: Samer Mohammed Omar, Ashburn, VA (US)

(72) Inventor: Samer Mohammed Omar, Ashburn, VA (US)

(21) Appl. No.: 13/282,786

(22) Filed: Oct. 27, 2011

(51) Int. Cl. G06Q 10/06

(52) U.S. Cl. 705/7.14

(57) ABSTRACT

The present invention provides a method and system for tracking career data using a computing environment. In one embodiment, this operates in a software as a service platform across a networked environment. The method and system includes receiving user career data from a computing input source and electronically generating a ranking of the user career data against general career data. The method and system further includes electronically generating a gap analysis of the user career data from the general career data, wherein the gap analysis includes at least one determination of delta factors between the user career data and the general career data. Whereupon, the method and system includes providing, as an electronic output, at least one suggested career activity for the user based on the gap analysis, such that the performance of the career activity improves the ranking of the user career data.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF INVENTION

The present invention relates generally to data management systems and more specifically to the collection, tracking and processing of career data in a computing environment for a variety of users.

### BACKGROUND OF THE INVENTION

Human capital development and talent management is a core challenge for not only expanding businesses, but individuals in the workforce. These development and management functions are difficult, expensive and typically inefficient using traditional methods of consultancy and enterprise software.

By way of example, the Information Communications and Technology (ICT) professions are challenged by the pace of technology and skill developments. In the ICT space, it is imperative to track employee skills and proficiencies, so as to not only manage the existing workforce, but also note employee needs for training and project assignments. Most human resource departments cannot keep up with the fast-paced changing environment, and such a failure to actively monitor the employees' career development and qualifications can lead to institutional concerns including optimized use of employees, effects on employee morale, employee retention, and overall lost productivity.

Currently, there exist many disparate systems and software programs that provide basic level of employee and career tracking data. These systems operate in a traditional silo environment, either producing results for system-specific functionality or these systems are loosely integrated with limited functionality therebetween.

For example, employee management software can track employee statistic and human resource related information for various employees. These systems will track generalized information as received by the system, including for example employee name, background, pay, length of service, etc. These systems are primarily data tracking and reporting systems, electronically saving submitted information with the ability to generate reporting features.

This career data continues to exist in the various silos, failing to account for cross-platform benefits. Another recent phenomenon is the development of business and social media web-based platforms. These computing platforms provide a central networking repository where users enter their professional information and create networking connections with co-workers, contacts and associations. Users update this information as their careers and accomplishments progress and users generate their professional network.

Again, this linking up between different users operates in a silo, where the data is essentially exclusively contained within that social media platform. Similarly, the other career and professional development platforms fail to inter-operate. This leaves major knowledge gaps for personal-use, businesses, educational institutions and others. This also creates many negative repercussions on the efficiency of the current workforce, the career advancement and upward mobility of professionals. It limits the usefulness of the various computing silos by failing to have cross-communication between these systems, platforms and the data they contain.

As such, there exists a need for a method and system that tracks and manages career data for use across multiple computing platforms.

### SUMMARY OF THE INVENTION

The present invention provides a method and system for tracking career data using a computing environment. In one embodiment, this operates in a software as a service platform across a networked environment. The method and system includes receiving user career data from a computing input source and electronically generating a ranking of the user career data against general career data. The method and system further includes electronically generating a gap analysis of the user career data from the general career data, wherein the gap analysis includes at least one determination of delta factors between the user career data and the general career data. Whereupon, the method and system includes providing, as an electronic output, at least one suggested career activity for the user based on the gap analysis, such that the performance of the at least one suggested career activity improves the ranking of the user career data against the general career data.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 illustrates a system diagram of one embodiment of a computing system for tracking career data;

FIG. 2 illustrates a block diagram of a computing system providing a method for career data tracking;

FIG. 3 illustrates a graphical representation of one embodiment of a career data database and its multiple data sources;

FIG. 4 illustrates a flowchart of the steps of one embodiment of a method for career data tracking;

FIG. 5 illustrates a block diagram of one embodiment of a computing process flow; and

FIGS. 6-11 illustrate sample screen shot of career dashboard displays.

### DETAILED DESCRIPTION

In the following description, reference is made to the accompanying drawings that form a part hereof, and in which is shown by way of illustration specific embodiments in which the invention may be implemented. It is to be understood that other embodiments may be utilized and design changes may be made without departing from the scope of the present invention.

It is well understood and appreciated that a user's career background says a lot about a user's future abilities. The user's credentials and other career data provide a trove of information about the user, especially in environments where computerized screen techniques are further improving the filtering process for job applicants and job seeking operations, as well as employee and business knowledge management within a company. The user's career placement can be characterized as a ranking value relative to any number of benchmarks, and this ranking is then usable for any number of benefits as described below. For example, one benefit is in an employee hiring process, whereby job applicants can determine jobs for which they are best qualified and then seek application. Another example is career management, such as tracking a user's career to determine where the user needs to improve his or her background/experience to keep pace with his or her co-workers or otherwise progress to higher employment levels.

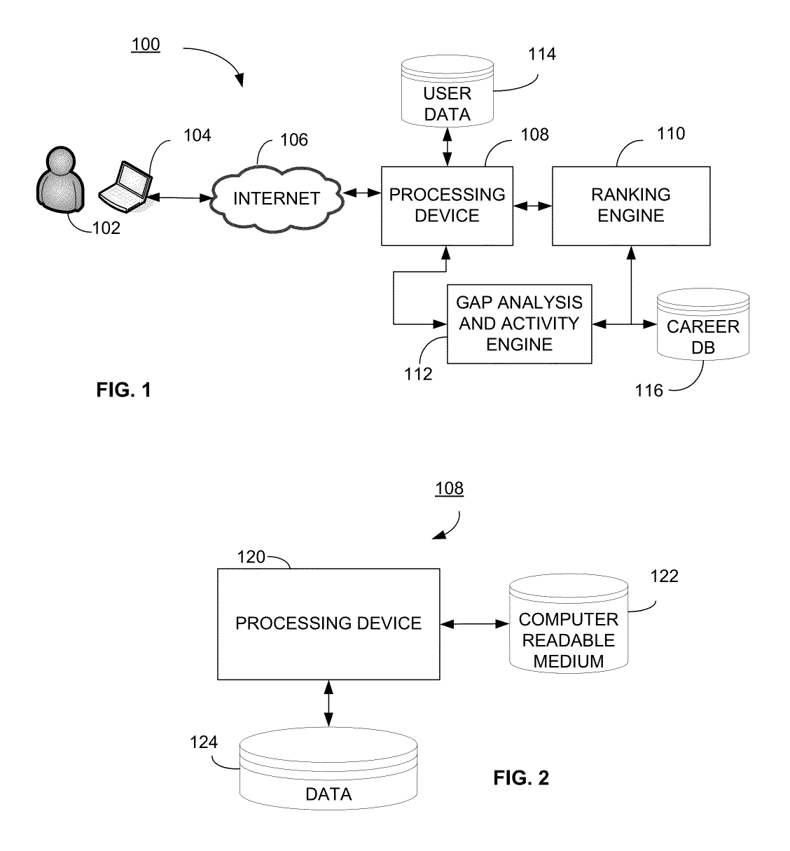

FIG. 1 illustrates a computing system 100 including a user 102, user input computing device 104, network connection 106 and processing device 108. The system 100 additionally includes a ranking engine 110, a gap analysis and activity engine 112 and at least two data storage devices including a user data storage device 114 and career data storage device 116.

The user 102 may be any relevant user including an employee, a human resource manager, an individual in his or her personal capacity, a supervisor or other non-HR person. The computing device 104 may be any device capable of receiving and transmitting input, including but not limited to a laptop or mobile computing device, a desktop computer, and/or a smart phone or tablet computer. The network 106 may be any network including but not limited to an intranet or the Internet, as well as any suitable private or public network connection allowing for communication between the computing device 104 and the processing device 108.

The processing device 108 may be any suitable computing device operative to perform processing operations, as described in further detail below. The processing device 108 may be one or more processing devices in a central or distributed computing environment, including operating on a single computing platform or computing and sharing resources across any number of platforms. The processing device 108 is illustrated in FIG. 1 as a single component for convenience purposes only and it is recognized that this device 108 can be multiple processors connected across any suitable networked environment as recognized by one skilled in the art.

The data storage devices 114 and 116 may be any suitable type of data storage device and may be individual devices or representative of multiple storage locations across one or more networks. By way of example, the database 114 may include data storage across multiple servers or computing systems networked together in a distributed environment. Wherein, the data 114 stores user data, as described in further detail below, and the career data database 116 stores career data, additionally as described in detail below. Generally, career data stored in the career data database includes data relating to skills, experience, education, publications, professional affiliations, networks, endorsements and any other data relating to a persons career and/or professional development.

The ranking engine 110 includes one or more processing device operative to perform ranking operations. In one embodiment, the engine 110 may be software or other executable code executed in one or more processing devices for the performance of ranking operations. Similarly, the gap analysis and activity engine 112 may be software or other executable code executed in one or more processing devices for the performance of operations described herein below.

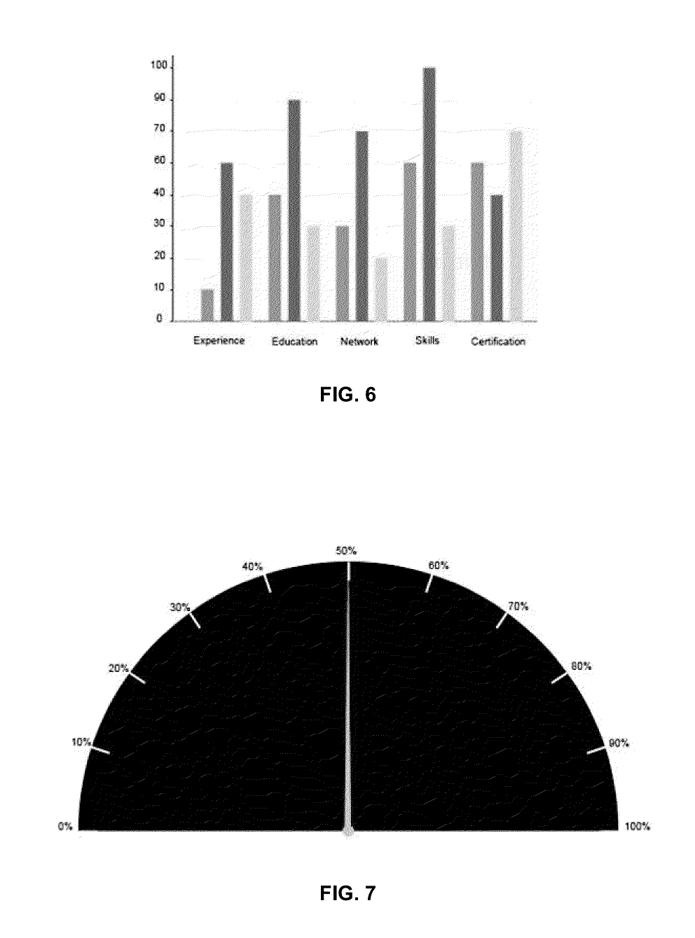

It is recognized by one skilled in the art that various processing and communication components of FIG. 1 have been omitted for brevity purposes only. Various embodiments of the operations of the system 100 are described in further detail below, including but not limited to the flowchart of FIG. 4.

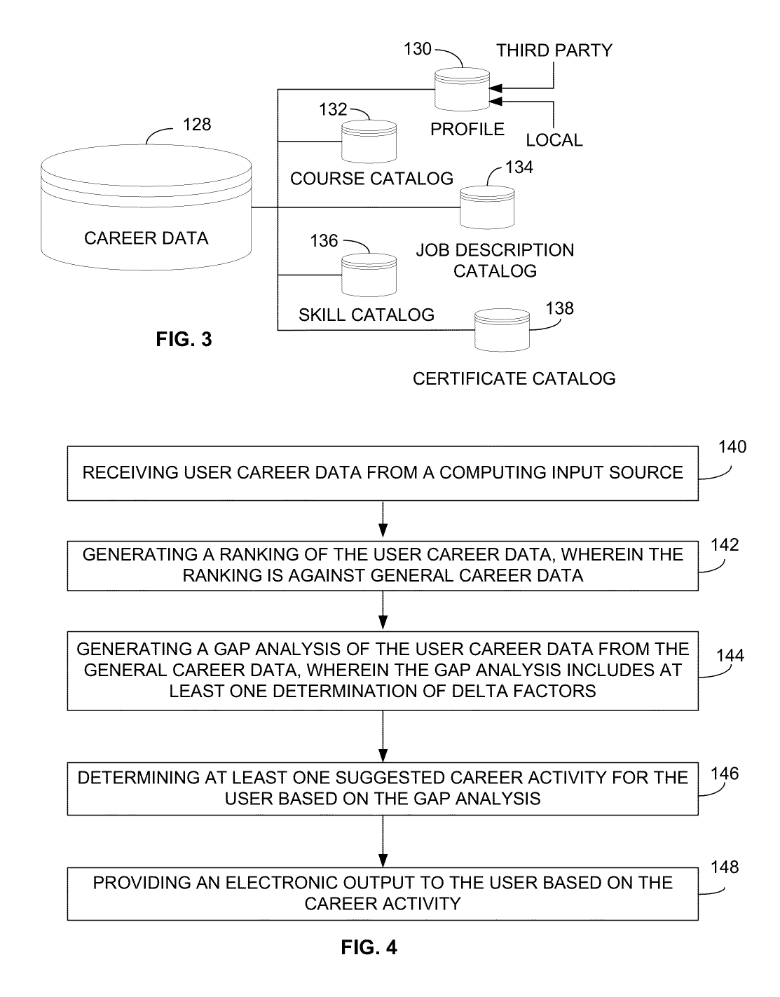

For further reference, FIG. 2 illustrates one embodiment of the processing device 108 including one or more processing devices 120, computer readable medium 122 and data storage device 124. The computer readable medium having executable instructions stored therein and the data storage device 124 including data available by the processing device for performing processing operations thereupon.

As the embodiments described below, various embodiments include the operations performed by the processing device 120 in response to the executable instructions from the computer readable medium 122, in accordance with known processing techniques recognized by those skilled in the art. The processing operations of the processing device 120 may be upon the data stored in the database, wherein the database may be any suitable storage device including for example databases 114 and/or 116.

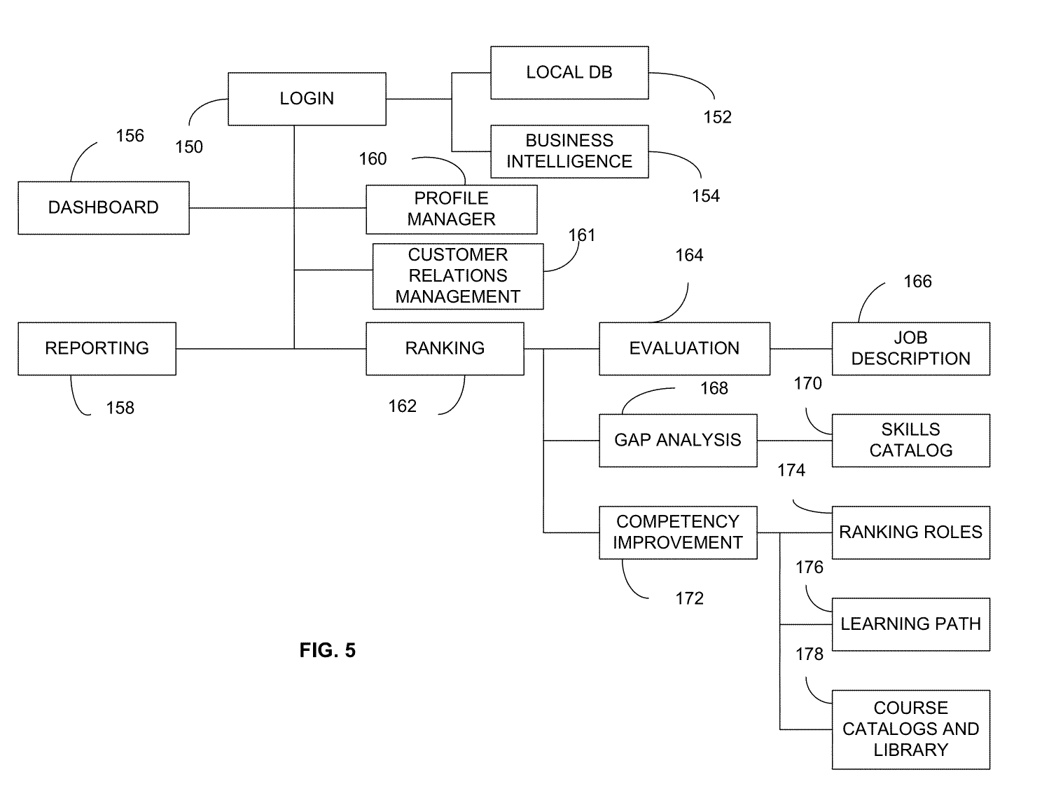

FIG. 3 illustrates a block diagram of one embodiment of the data compilation of the career data database 128, which may be similar to or identical to the database 116 of FIG. 1. The career data database 128 includes data from any number of variety of sources and the collective storage of that data therein.

For example, the database 128 includes profile data from a profile data database 130. The profile data may be from any number of sources including third party sources, such as for example external networked locations like a professional networking website. The profile data may be local to the computing system, such as data from registered account users. The profile data generally contains profile data relating to the user and the user's credentials. Typical data may include the user's educational background, the user's certification, the user's training credentials, the user's work experience, the user's demographic/personal information, the user's career objectives, as well as any other suitable data.

The career data database 128 additionally receives data from a course catalog database 132. This database 132 includes information relating to available educational/training courses. This data may be categorized by user skill level pre-requisites, course topic, course content and any other information relating to the providing of training or other types of knowledge and/or skill improvement activities for attendees.

The career data database 128 additionally receives data from a job description catalog database 134. The catalog data in the database 134 relates to job descriptions. It is understood that the present processing system includes standardized job descriptions, therefore disparate job listings can be equally compared against each other. Therefore, the job description catalog includes any number of job descriptions, including qualification requirements, e.g. education, skill, certification, etc.

The career data database 128 additionally receives data from a skill catalog database 136. The skill catalog data includes data for professional skill levels describing and defining skills required for various professions, including but not expressly limited to, job descriptions, background data, job requirement data, job certification data, pay or income data, demographic information, among others.

The career data database 128 additionally receives data from a certificate catalog database 138. This data includes information relating to certification levels. In some professions, including in the ICT profession, certification is required for various levels of career advancement. Therefore, this data includes a catalog of certifications, including for example skill requirements and educational requirements for reaching various certification levels. Based on the certification data, it is understood if a user is certified, can be certified, should be certified and how certification can affect/improve a persons professional development.

Therefore, the career data database 128 includes a large collection of career data usable for the herein described operations. This data may include pre-processing for removing extraneous data points, as well as reformatting or otherwise modifying the data for consistent usable data from multiple sources in a single processing platform.

FIG. 4 illustrates a flowchart of the steps of one embodiment of a method tracking career data. The steps of the flowchart of FIG. 4 may be performed by the system 100 of FIG. 1, including processing operations performed by the processing device 120 of FIG. 2 in response to executable instructions.

In the methodology of FIG. 4, a first step, step 140, is receiving user career data from a computing input source. This step may include any number of various embodiments, including the user 102 of FIG. 1 entering personal information including resume or personnel data, a manager or supervisor entering employee data, a HR professional entering HR employee data, a recruiting coordinator entering career data for candidates or clients, protected social community information for a specific user (e.g. LinkedIn®, Xing®, Facebook®), etc. With reference to FIG. 3, this data may include the profile data from database 130.

The receipt of the user career data may be via a web and/or WAP interface or other type of computing interface. For example, in a software as a service platform, the data entry may be via a web-based data entry portal running a local data entry page via a browser or other type of local resident software. As noted in FIG. 1, one embodiment includes receiving the user career data via the Internet 106 or third party data in various computing technologies, and is not limited for API internet-based and/or data exchange tools.

In the exemplary methodology of FIG. 3, a next step, step 142, is generating a ranking of the user career data, wherein the ranking is against general career data. With reference to FIG. 1, the data is received via the processing device 108 and passed to the ranking engine 110. The user data may be stored in the user data database 114 prior to ranking.

The ranking engine 110 operates to rank the career data across numerous and multiple career data platforms. The engine receives ranking factors and ranks the data based on these ranking factors.

In one embodiment, ranking factors may be generated based on computational analysis of the career data stored in career data database 116. In one example, ranking of career data may include ranking experience levels for employees. Using the example of the ICT professionals, it may be important to know not only computer and software qualifications, but also years of experience. So while different individuals may have complimentary experience backgrounds, those backgrounds may be defined by different terms or characterizations. For example, if a user is certified but has little actual experience, that qualification level must be comparable relative to someone who has no certification but a lot of actual experience. Therefore, the ranking engine 110 provides for quantifying the career data received from the user via the input source.

In one embodiment, the ranking step, 142, includes a first step to quantify the career data, or more specifically, elements of the career data, into value components. By way of example, the career data may be divided up into numerous categories, including education levels, certification levels, years of experience, etc. The data for each of these categories then reflects career data points, which is usable for career tracking.

Therefore, based on the generalization of the various forms of career data into a generally usable format, the career data itself is usable, regardless of the system used to enter the data, therefore the performance of career tracking can be done across numerous HR and business intelligence platforms. Prior techniques operating in silo-based systems failed to allow for the comparison of data from different systems, where career data in an HR system is not comparable to career data listed on a professional networking site. But by categorizing and ranking the data, these systems become interoperable.

In one embodiment, the ranking engine 110 operates a ranking algorithm that includes the weighting of multiple key performance indicators (KPIs). For example, the indicators may include education, professional network, experience level, skills, certifications and event and publications. For clarity, the professional network may include a determination of the individuals/professional to whom the user is networked, such as via a social or professional networking website. The algorithm provides a defined weighting factor for each of these indicators, where the weighting factors may be different for each indicator. The indicator is expressed in a numerical format, such as a binary representation. This indicator is then multiplied or weighted based on the weighting factor to generate a weighted indicator.

The weighted indicators are then combined to generate a collective value that represents the combination of all weighted indicators. For example, one embodiment may include a 64 bit representation. The education indicator is represented as a 14 bit value and then weighted. The networking indicator is represented as a 15 bit value and then weight. The experience is a series of 10 bits and then weighted. The skills element is a series of 15 bits and then weighted. The certification is a series of 10 bits then weight and the publication may be a 0 bit. It is recognized that the 64 bit embodiment is not a limiting embodiment and than suitable number of bits may be utilized.

The various indicators may be further compartmentalized based on make-up components. For example, education may be further subdivided with four bits representing a ranking of the user's university, five bits representing years of education and five bits representing any educational endorsement factors. For further illustration, if the user's school is in the top 10, the binary value may be “0001”; in the top 100, the binary value is “0010”; in the top 1000 the binary value is “0100”; and for all the rest “0000”. For years of education, high school may be “0001”; 2 years of education may be “00010”; BS/BA degree “00100”; MA/MS/MBA may be “01000”; PHD may be “10000” and all the rest at “00000”. Endorsements may be a binary representation of yes as “1000” and no as “0000”.

Similar delineations exist for other components of the indicators. Sub-categories of the indicators are assigned binary values and the collective, in this embodiment, 64 bit value represents the collective value of the user's professional experience. For example, additional sub indicators can be global ranking of the company and years of experience for the experience indicator; relevant job description and endorsement skill for skills, number of certificates and endorsements for the certificate indicator.

For further reference, an example of generating a ranking is described herein. In this example, a user provides career data input and it is determined the user's university ranking is in the top 59, the user has a Bachelor of Arts degree and no endorsed education. The user does not have a professional network. The user's experience is with a company having a global ranking in the top 2000, less than a year of experience and has not been professionally endorsed. The user's skills are compared to a standard dictionary of job skills and it is determined the user has 5 skills and no endorsed skills. The user has 2 professional certificates and no publications or events.

Therefore, based on this information, the ranking algorithm is able to generate a 64-bit value representing the user's professional status. The binary values are weighted according to indicator weighting values. The generated 64 bit value is then converted into a decimal value. In one embodiment, the conversion is a simple base-2 to base-10 conversion, e.g. taking the number 2 to the power of the binary value.

Having this base value, the algorithm may now perform the ranking. Ranking is based off a baseline value, which in this embodiment is the 64-bit value having all 1s. Thus, the baseline value translates to the decimal value of 2 to the 64^{th} power. Ranking is then determined based on division of the baseline value by the user's decimal value. This calculation generates a percentage value, indicating the user's percentage location from an ideal candidate having a perfect score.

In another example, a performance indicator can be endorsements or recommendations by network connections. Different embodiments provide for varying degrees of endorsements, including who can endorse a person and the weighted affect given various endorsements. For example, limitations can be placed so that qualifications are required to accept an endorsement, to help attune the veracity of the endorsements. For example, it may be desirable to prohibit someone endorsing another person's education unless that endorser had actually worked with the user, compared with someone endorsing someone merely because of the user's alma mater. Other various embodiments are readily envisioned, whereby the embodiments provide for improving the veracity of endorsements and giving further weight to the value of an endorsement in determining the user's professional rank, wherein endorsements provide a greater level of network feedback usable for a better career analysis for the user.

It is understood that the above algorithm and its associated indicator categories and values are representative in nature and not expressly limiting embodiments. Therefore, it is appreciated that other indicators may be envisioned and sub-indicators utilized as recognized by one skilled in the art.

In the methodology of FIG. 3, a next step, step 144, is to generate a gap analysis of the user career data from the general career data, wherein the gap analysis includes at least one determination of delta factors.

In this embodiment, the career data database 116 of FIG. 1 includes the career data assembled and based on a large sampling of career data. This data may be assembled and generated by mining or otherwise collecting various career data submissions across these numerous computing platforms. For example, career data may be acquired from an enterprise system managing HR data, career data may be acquired from social and business networking sites, from business intelligence tools, from user profile data, from recruiting and/or job databases, etc.

From the collective normalized career data, baseline data is usable for performing the comparison and generating the delta analysis. In one embodiment, the gap analysis is determined by a direct comparison of the user career normalized data values to the range of career data. Based on the above-described algorithm, there exists the readily ascertainable gaps on the user's ranking by determining where low values exists, the low binary values translating into a lower decimal value and hence a lower percentage relative to the baseline value. Therefore, the delta factor determination includes determining indicators wherein the user can readily improve his or her ranking, for example if the user only has a 2 year education degree, a delta factor includes the improvement of the user's ranking by seeking a four year Bachelor's degree.

In FIG. 3, a next step, 146, is determining at least one suggested career activity for the user based on the gap analysis. The gap analysis and activity engine 112, of FIG. 1, may perform this step. This determination is a usable translation of the gap analysis and the delta factors. Using the above example of education, it is thus determinable that a suggested career activity is to increase the user's education level from a 2 year degree to a 4 year degree. These career activities can run the spectrum of available activities based on the key performance indicators and sub-indicators. For example, career activities can include, but are not limited to, increasing one's professional network, acquiring additional certification, receiving professional endorsements, seeking employment with a more highly regarded employer, speaking engagements, etc.

Therefore, in this embodiment, the final step, step 148, is providing an electronic output to the user based on the career activity. With respect to FIG. 1, this may include the processing device 108 generating an output display to the user 102 via the network 106. In one embodiment, resultant features may be visual displays of the user's career data relative to the general career data set. For example, the user may be provided with a visual display illustrating the percentages and ranges of the user's career statistics relative to the industrial means, medians and/or ranges. In another example, the resultant feature may be a trajectory or career path for the user indicating where the user stands relative to peers and how to advance in his or her career. In this career path example, it may be determinable that if the user becomes certified for a particular software product, the user can then advance in the rankings, so the resultant feature includes not only a display of the user's rankings, but also a recommendation for advancement. As noted above, this display may include any number of possible resultant features, including training/certification recommendations, graphical displays, career trajectories display data, resume/social networking displays including networking connections and/or recommendations, etc.

In embodiments above, the user career data may include any data usable for career information. This data may include, but is not limited to, education level, job training, performance review, job experience and professional recognition (award) data. In further embodiments, the user data may be part of an on-going tracking system that tracks the user data across multiple years and/or careers paths. This user data may include timely updated information, such updated from annual reviews, quarterly training certification/re-certification periods, etc.

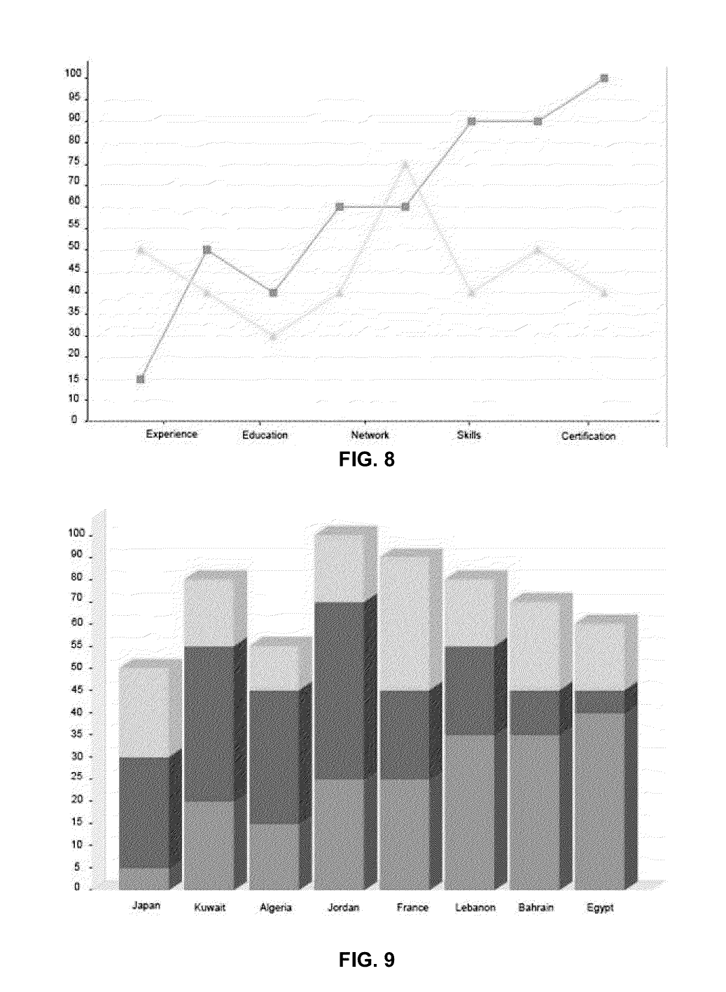

FIG. 5 illustrates an operational flow diagram of various embodiments of the career data tracking system. The elements in FIG. 5 represent software modules including executable code executed on one or more processing devices for providing the underlying functionality as noted herein. The data flow includes a user login 150 with access to a local database 152 and a business intelligence system 154. From the login 150, the user has access to four components, a dashboard 156, reporting module 158, a profile manager 160, customer relationship management module 161 and a ranking module 162.

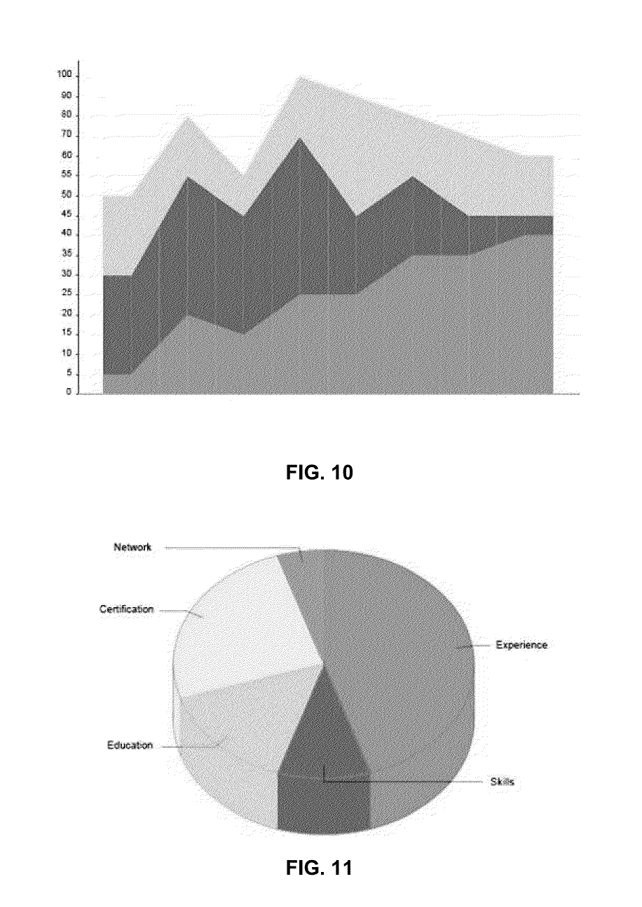

The functionality of a user via the login 150 allows for the tracking of career data and the evaluation of the data for tracking, development and advancement interactivity. For example, the dashboard 156 may provide the visual interface allowing a user to track and interact with the data. For example, FIGS. 6-11 illustrate a sample screenshots of a dashboard display showing the career tracking data. The data may be for the user or for an employee, prospective employee or any other type of individual wherein career data is tracked.

In the example of a social networking environment, the profile manager may include the input of the user's background, education, certifications, etc. The manager 160 may include the display of public information as well as the retention of private information. In the example of job listings, the profile manager may include listing of openings and/or qualifications for various parties to facilitate the submission of applications. The reporting module 158 may include functionality for mining the career data for the user, as well as the data for the general career data accessible via the normalization techniques described above.

The ranking module 162 includes additional modules, including the noted embodiments illustrated herewith. For example, an evaluation module 164 accesses and processes job description data 166, this may include normalized or otherwise generalizing job application data, where different job listing use different terminology. The evaluation engine 164 may include processing for analyzing the terminology of the job description and performing an analysis relative to the user career information, including for example a recommendation for whether the user may be qualified for applying for a particular job.

In another embodiment of the ranking module, gap analysis engine 168 processes skills catalog data 170. Based on this information, the engine 168 can determine the differences between a user's current skills and reference information, such as generalized career data as noted above.

Similarly, the ranking engine 162 additionally includes a competency improvement engine 172 for improving the user's credentials or professional skills. This engine 172 includes accessing data relating to ranking roles 174, learning path 176 and course catalogs and library 178. The rankings roles include data that indicating career position rankings and the advancement in a career by having a greater career role, how that affects the user's ranking 162. Learning path 176 includes data for how to increase education and knowledge basis for the users, including the ability for educational courses, training courses, certification(s), etc. Similarly, the course catalogs and library 178 provide listings of available resources for improving the user's knowledge base, including with reference to data from the learning path 176. The data 174, 176 and 178 provide resources for the user to improve his or her credentials through improving the user's competency level, therefore the engine 172 is operative to provide recommendations or feedback for the user based on the available resources 174, 176 and 178.

Accordingly, the herein described method and system for tracking career data improves over the static prior techniques. Prior techniques for career data operated in discrete systems lacking the ability to share data. The present method and system improves by developing a standard for job descriptions, including roles and responsibilities, developing a standard for skills definitions, standard for career development/career paths. The method and system provides for standards for ranking professionals based on factors including education, background, endorsement from connections/relationships, professional experience, professional certifications, publications, etc. The method and system develops professional networks and relationships based on career goals, develops connections between job description and skills with vendor solutions. The method and system provides effective recruiting services and training services, as well as career management services. Users, including consultancy firms and enterprises are able to rank staff and identify critical personnel based on the standardized modeling, as well as identify staff for work flow reduction and/or re-organization based on the normalized data. Moreover, the method and system additionally reduces the time to identify resources internally or externally for recruitment, as well as reduce time to identify vendors or suppliers for projects based on needs analysis.

As described above, the systems and method provide for generalizing career data and then using this generalized career data to provide a ranking of a user. This user ranking is then usable for any number of benefits, including but not limited to employment eligibility to applying candidates to individuals deciding if they want or should apply. The user ranking is usable for internal employee management. Moreover, based on the generation of a ranking and the generalized career data, the system does generate a unified number assignable to the user's career. By analogy, individuals have credit scores that indicate their creditworthiness, the above-described technique generalized a corresponding professional score for the user. This score is usable for any number of assessment operations, as well as usable for user improvement, including recommendations for improving the user's ranking by certification, education, networking, etc. As such, under the present technique, user's career data is generalized and ranked providing not only a general career rating value for the user, but corresponding knowledge for the user and the business environment based on this rating.

FIGS. 1 through 11 are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, Applicant does not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein.

1. A computerized method for tracking career data, the method comprising:
receiving user career data from a computing input source, the career data indicating a plurality of performance indicators representing career information of the user;
determining a veracity or validation factor of the user career data based at least on a business network interface, wherein the business network interface provides business network connections to confirm veracity of at least a portion of the user career data;
electronically, using a computing device, generating a ranking of the user career data based on the validation of the user career data and a determination of values for each of the plurality of performance indicators in comparison to baseline values for each of the performance indicators representing general career data;
electronically generating, using the computing device, a gap analysis of the user career data from the general career data, wherein the gap analysis includes at least one determination of delta factors between the performance indicators of the user career data and the performance indicators of the general career data;
electronically calculating, using the computing device, a resultant feature relating to the user and the ranking of the user career data, the resultant feature electronically determined based on the gap analysis; and
providing, as an electronic output, the resultant feature of at least one suggested career activity for the user that improves the ranking of at least one of the performance indicators of the user career data against the performance indicators of the general career data.

2. The method of claim 1, wherein the performance indicators of the user career data includes at least one of: education level, job training data, performance review data, job experience data and professional recognition data.

3. The method of claim 1 further comprising:
receiving the user career data via a computerized interface across a networked connection from at least one of: a human resource professional or the user.

4. The method of claim 1, wherein the resultant feature includes determining job applicability data; and
generating a job advancement determination based on the job applicability data, including a recommendation for at least one of: hiring the user, promoting the user, generating a job performance review for the user, and determining a compensation amount for the user.

5. (canceled)

6. The method of claim 1, wherein the resultant feature includes determining at least one job training program for the user.

7. The method of claim 1, wherein the resultant feature includes determining a career ranking for the user compared with a generalized career data set.

8. The method of claim 1 further comprising:
receiving updated user career data relating to the user; and
tracking a user career based on the updated career data based on updating the values of the performance indicators of the user career data.

9. The method of claim 1 further comprising:
accessing the business network interface providing a business networking platform indicating a plurality of professional connections of the user confirming the veracity of the at least a portion of the user career data;
integrating the user career data with the plurality of professional relationships of the user; and
generating user network resultant features from the data integration.

10. A system for tracking career data, the system comprising:
at least one non-transitory computer readable memory device having executable instructions stored therein; and
a processing device, in operative communication with the memory device for receiving the executable instructions therefrom such that the processing device, in response to the executable instructions, is operative to:
receive user career data from a computing input source, the career data indicating a plurality of performance indicators representing career information of the user;
determine a veracity or validation factor of the user career data based at least on a business network interface, wherein the business network interface provides business network connections to confirm veracity of at least a portion of the user career data;
electronically generate a ranking of the user career data based on a determination of values for each of the plurality of performance indicators in comparison to baseline values for each of the performance indicators representing general career data;
electronically generate a gap analysis of the user career data from the general career data, wherein the gap analysis includes at least one determination of delta factors between the performance indicators of the user career data and the performance indicators of the general career data;
electronically calculate a resultant feature relating to the user and the ranking of the user career data, the resultant feature electronically determined based on the gap analysis; and
provide, as an electronic output, the resultant feature of at least one suggested career activity for the user that improves the ranking of at least one of the performance indicators of the user career data against the performance indicators of the general career data.

11. The system of claim 10, wherein the performance indicators of the user career data includes at least one of: education level, job training data, performance review data, job experience data and professional recognition data.

12. The system of claim 10, wherein the processing device is further operative to, in response to the executable instructions:
receive the user career data via a computerized interface across a networked connection from at least one of: a human resource professional or the user.

13. The system of claim 10, wherein the resultant feature includes determining job applicability data, the processing device is further operative to, in response to the executable instructions:
generate a job advancement determination based on the job applicability data, including a recommendation for at least one of: hiring the user, promoting the user, generating a job performance review for the user, and determining a compensation amount for the user.

14. (canceled)

15. The system of claim 10, wherein the resultant feature includes determining at least one job training program for the user.

16. The system of claim 10, wherein the resultant feature includes determining a career ranking for the user compared with a generalized career data set.

17. The system of claim 10, wherein the processing device is further operative to, in response to the executable instructions:
receive updated user career data relating to the user; and
track a user career based on the updated career data based on updating the values of the performance indicators of the user career data.

18. The system of claim 10, wherein the processing device is further operative to, in response to the executable instructions:
access the business network interface providing a business networking platform indicating a plurality of professional connections of the user confirming the veracity of the at least a portion of the user career data;
integrate the user career data with the plurality of professional relationships of the user; and
generate a user network resultant features from the data integration.

19. The method of claim 1, wherein a performance indicator is a professional network indicator, the method further comprising:
determining a plurality of professional network connections for the user, including determining individuals to whom the user has a professional relationship, and
determining the professional network indicator based on applying a weighting factor to the plurality of professional network connections.

20. The system of claim 10, wherein a performance indicator is a professional network indicator, the processing device further operative to:
determine a plurality of professional network connections for the user, including determining individuals to whom the user has a professional relationship, and
determine the professional network indicator based on applying a weighting factor to the plurality of professional network connections.

21. The method of claim 1 wherein the performance indicators represent bit values combined to generate a collective value, the collective value representing a professional score for the user.

22. The system of claim 10 wherein the performance indicators represent bit values combined to generate a collective value, the collective value representing a professional score for the user.
